(19) United States
(12) Patent Application Publication
(10) Pub. No.: US 2024/0196369 A1
(43) Pub. Date: Jun. 13, 2024

(54) PAGING PROCESSING METHOD AND APPARATUS

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 18/286,555

(22) PCT Filed: Apr. 19, 2021
(86) PCT No.: PCT/CN2021/088234

§ 371 Date: Oct. 11, 2023

(51) Int. Cl. H04W 68/02; H04L 9/32

(52) U.S. Cl. CPC H04W 68/02; H04L 9/3242; H04L 2209/80

(57) ABSTRACT

Embodiments of the present application relate to the technical field of wireless communications, and disclose a paging processing method and apparatus. The method is executed by a terminal device, and includes: receiving a paging request for a non-current connection system forwarded by an access network device; and in response to a current connection system being in a busy state, sending an RRC recovery request message for removing a recovery reason information element to the access network device, or sending a busy indication RRC message to the access network device, where the terminal device has a first communication card and a second communication card, the terminal device communicates with the current connection system by using the first communication card, and the terminal device communicates with the non-current connection system by using the second communication card.

### CROSS-REFERENCE

The present application is a U.S. national phase application of International Application No. PCT/CN2021/088234, filed on Apr. 19, 2021, the contents of which are incorporated herein by reference in their entireties for all purposes.

### BACKGROUND

A terminal device equipped with a plurality of Universal Subscriber Identity Modules (USIMs) may perform concurrent registration over the 3rd Generation Partnership Project (3GPP) Radio Access Technology (RAT) associated with the plurality of USIMs. When the terminal device equipped with the plurality of USIMs communicates with a system (called a current connection system) associated with one of the USIMs, the terminal device equipped with the plurality of USIMs may need to perform certain activities (e.g., listening to paging, responding to paging, performing mobility updates, etc.) in another system (called a non-current connection system) associated with a USIM that is different from the above USIM.

In a case that the terminal device equipped with the plurality of USIMs receives a paging from the non-current connection system notifying a pending Mobile Terminated (MT) service, if there is an ongoing service in the current connection system, the terminal device equipped with the plurality of USIMs may send a busy indication to a network side, and the terminal device equipped with the plurality of USIMs carries the busy indication in a specific NAS message.

### SUMMARY

The present disclosure relates to the field of communication technologies, and more particularly, to a method and apparatus for processing a paging.

In a first aspect, embodiments of the present disclosure provide a method for processing a paging, which is performed by a terminal device. The method includes: receiving a paging request for a non-current connection system forwarded by an access network device; and in response to a current connection system being in a busy status, sending an RRC resume request message with a resume cause information element excluded to the access network device, or sending a busy indication RRC message to the access network device, where the terminal device is equipped with a first communication card and a second communication card, the terminal device is in communication with the current connection system through the first communication card, and the terminal device is in communication with the non-current connection system through the second communication card.

In a second aspect, embodiments of the present disclosure provide another method for processing a paging, which is performed by an access network device. The method includes: forwarding a paging request for a non-current connection system to a terminal device; and in response to receiving an RRC resume request message of the terminal device with a resume cause information element excluded or receiving a busy indication RRC message of the terminal device, determining that a current connection system of the terminal device is in a busy status.

In a third aspect, embodiments of the present disclosure provide a terminal device, including a processor and a memory. A computer program is stored in the memory, and the processor is configured to perform the computer program stored in the memory to cause the apparatus to execute the method described in embodiments of the first aspect of the present disclosure.

In a fourth aspect, embodiments of the present disclosure provide a network device, including a processor and a memory. A computer program is stored in the memory, and the processor is configured to perform the computer program stored in the memory to cause the apparatus to execute the method described in embodiments of the second aspect of the present disclosure.

It is to be understood that both the foregoing general description and the following detailed description are exemplary and explanatory only and are not restrictive of the present disclosure.

### BRIEF DESCRIPTION OF THE DRAWINGS

In order to more clearly explain technical solutions in embodiments or the background of the present disclosure, the drawings required to be used in the embodiments or the background of the present disclosure will be described below.

FIG. 1 is a schematic flowchart of a method for processing a paging according to an embodiment of the present disclosure;

FIG. 2 is a schematic flowchart of another method for processing a paging according to an embodiment of the present disclosure;

FIG. 3 is a schematic flowchart of another method for processing a paging according to an embodiment of the present disclosure;

FIG. 4 is a schematic diagram of an input parameter and an output result of an integrity algorithm NIA in an embodiment of the present disclosure;

FIG. 5 is a schematic flowchart of another method for processing a paging according to an embodiment of the present disclosure;

FIG. 6 is a schematic flowchart of another method for processing a paging according to an embodiment of the present disclosure;

FIG. 7 is a schematic diagram of an input parameter and an output result of an integrity algorithm NIA in an embodiment of the present disclosure;

FIG. 8 is a schematic flowchart of another method for processing a paging according to an embodiment of the present disclosure;

FIG. 9 is a schematic flowchart of another method for processing a paging according to an embodiment of the present disclosure;

FIG. 10 is a schematic flowchart of another method for processing a paging according to an embodiment of the present disclosure;

FIG. 11 is a schematic flowchart of another method for processing a paging according to an embodiment of the present disclosure;

FIG. 12 is a schematic flowchart of another method for processing a paging according to an embodiment of the present disclosure;

FIG. 13 is a schematic flowchart of receiving, by an access network device, a terminal context sent by a core network device according to an embodiment of the present disclosure;

FIG. 14 is a schematic structural diagram of an apparatus for processing a paging according to an embodiment of the present disclosure;

FIG. 15 is a schematic structural diagram of another apparatus for processing a paging according to an embodiment of the present disclosure;

FIG. 16 is a block diagram of a terminal device according to an embodiment of the present disclosure; and

FIG. 17 is a schematic structural diagram of a network device according to an embodiment of the present disclosure.

### DETAILED DESCRIPTION

In a case that a terminal device equipped with a plurality of USIMs receives paging from a non-current connection system notifying a pending Mobile Terminated (MT) service, if the terminal device equipped with the plurality of USIMs determines that the MT service is less important than an ongoing service and would rather keep the ongoing service in a current connection system, there may be the following two cases.

In a first case, the terminal device equipped with the plurality of USIMs simply responds to the paging from the non-current connection system following the existing procedures, which will however interrupt the ongoing service in the current connection system.

In a second case, the terminal device equipped with the plurality of USIMs does not respond to the paging from the non-current connection system, which will however make the non-current connection system keep paging the terminal device equipped with the plurality of USIMs by escalating the paging coverage to an even larger area, causing the waste of resources of the non-current connection system.

One of the solutions proposed in 3GPP TR 23.761 Clause 6.3 addressing the above problems is to allow the terminal device equipped with the plurality of USIMs to send a busy (BUSY) indication as a response to the non-current connection system paging it. When a terminal device being paged is in a Radio Resource Control Idle (RRC-Idle) state, an Access and Mobility Management Function (AMF) may stop paging after receiving the busy indication, hence system resources could be saved and the ongoing service in the current connection system will not be interrupted. However, when the terminal device being paged is in an RRC-Inactive state, a Radio Access Network (RAN) does not need to forward the busy indication from the terminal device to the AMF, avoiding escalating the paging coverage.

However, concerning a security aspect of the busy indication, if it is not protected during the transmission, it could be eavesdropped, tampered, replayed or even fabricated by an attacker. Such threats will mislead a network side to behave in a way not expected by the terminal device equipped with the plurality of USIMs, which will cause a Denial of Service (DOS) attack on the terminal device and the network side. A proposed solution in the 3GPP TR 33.873 protocol addressing this issue is to reuse the existing Non-Access Stratum (NAS) signaling security mechanism to protect the busy indication carried in a NAS message sent by the terminal device in the RRC-Idle to the AMF. However, when a 5G base station (gNB for short) obtains the busy indication sent by a terminal device in an RRC-Inactive state, gNB will not send the busy indication to the AMF, and the busy indication will not be carried in the NAS message sent by the terminal device in the RRC-Inactive state. Thus, the above way to carry the busy indication in a specific NAS message is not applicable to the terminal device in the RRC-Inactive state.

To address the above problems, the present disclosure provides a method and apparatus for processing a paging.

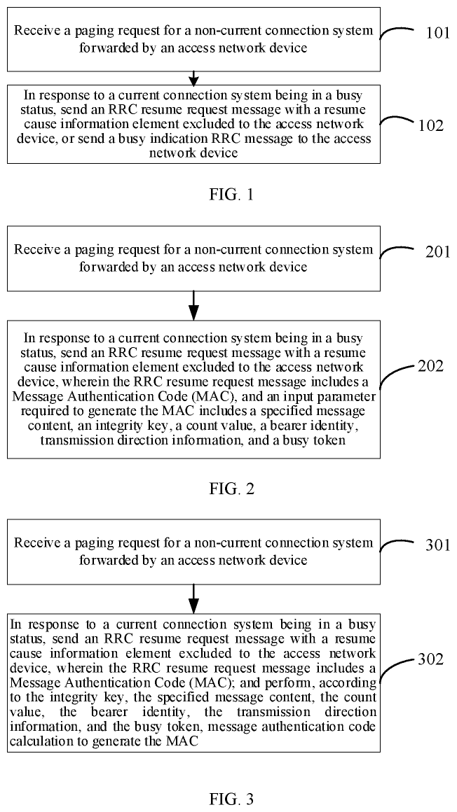

FIG. 1 is a schematic flowchart of a method for processing a paging according to an embodiment of the present disclosure. The method for processing the paging may be performed by a terminal device.

The terminal device may refer to a device providing voice and/or data connectivity to a user, a handheld device with a wireless connectivity function, other processing device connected to a wireless modem, etc. In different systems, the name of the terminal device may also be different. For example, in 5G systems, the terminal device may be called User Equipment (UE). A wireless terminal device may communicate with one or more Core Networks (CNs) via a RAN. The wireless terminal device may be a mobile terminal device, such as a mobile phone (or “cellular” phone) and a computer with the mobile terminal device, for example, a portable, pocket-sized, hand-held, computer-built or vehicle-mounted mobile device that exchanges language and/or data with the radio access network.

For example, the terminal device may be a Personal Communication Service (PCS) phone, a cordless phone, a Session Initiated Protocol (SIP) phone, a Wireless Local Loop (WLL) station, a Personal Digital Assistant (PDA), or the like. The wireless terminal device may also be referred to as a system, a subscriber unit, a subscriber station, a mobile station, a mobile, a remote station, an access point, a remote terminal, an access terminal, a user terminal, a user agent, and a user device, which is not limited in embodiments of the present disclosure.

As shown in FIG. 1, the method for processing the paging may include the following steps 101 and 102.

In the step 101, a paging request for a non-current connection system forwarded by an access network device is received.

The access network device as a base station is taken as an example. The base station may include a plurality of cells that provide services to the terminal device. Depending on specific application scenarios, each cell may also contain a plurality of Transmitting Receiving Points (TRPs), or may be a device in an access network that communicates with the wireless terminal device over one or more sectors on an air interface, or may have other names. For example, the base station involved in embodiments of the present disclosure may be a Base Transceiver Station (BTS) in Global System for Mobile communications (GSM) or Code Division Multiple Access (CDMA), or a NodeB in a Wide-band Code Division Multiple Access (WCDMA). It may also be an evolutional Node B (eNB or e-NodeB for short) in a long term evolution (LTE) system, a 5G base station (gNB for short) in a 5G network architecture (next generation system), or a Home evolved Node B (HeNB), a relay node, a femto, a pico, etc., which are not limited in embodiments of the present disclosure.

The terminal device is equipped with a first communication card and a second communication card. The terminal device uses the first communication card to communicate with the current connection system, and the terminal device uses the second communication card to communicate with the non-current connection system.

In embodiments of the present disclosure, the current connection system refers to a system corresponding to a network that the terminal device currently accesses to, and the system is in a connection mode with the terminal device. The non-current connection system refers to a system corresponding to a network that the terminal device does not currently access to, and the system is in an idle mode with the terminal device. In the present disclosure, in order to facilitate the differentiation of different communication cards in the terminal device, a communication card in the terminal device that communicates with the current connection system may be called the first communication card, and a communication card in the terminal device that communicates with the non-current connection system may be called the second communication card.

The terminal device equipped with two communication cards, and the two communication cards respectively as a mobile communication card and a telecommunications communication card are taken as an example for illustration. Assuming that the terminal device communicates with other terminal devices through the mobile communication card, and in this case, the current connection system may be a system corresponding to a mobile network, and the non-current connection system may be a system corresponding to a telecommunications network. The terminal device equipped with two communication cards, and the two communication cards both as mobile communication cards are taken as an example for illustration, and in this case, the current connection system may be system 1 corresponding to the mobile network, and the non-current connection system may be system 2 corresponding to the mobile network., that is, both system 1 and system 2 are systems corresponding to the mobile network.

In embodiments of the present disclosure, the terminal device may use the second communication card to receive the paging request for the non-current connection system forwarded by the access network device, and the paging request is used to page the terminal device.

In some embodiments of the present disclosure, a core network device of the non-current connection system may send the paging request to the terminal device via the access network device. Correspondingly, the terminal device may use the second communication card to receive the paging request forwarded by the access network device which is sent by the core network device of the non-current connection system.

In the step 102, in response to the current connection system being in a busy status, an RRC resume request message with a resume cause information element excluded is sent to the access network device, or a busy indication RRC message is sent to the access network device.

As an example, after receiving the paging request, the terminal device may determine whether the current connection system is in the busy status. In a case that the current connection system is in the busy status, the terminal device may generate the RRC resume request message (RRCResumeRequest) with the resume cause information element excluded, and send the RRC resume request message to the access network device. After receiving the RRC resume request message, the access network device may determine that the current connection system of the terminal device is in the busy status. It should be noted that the RRC resume request message with the resume cause information element excluded is used to indicate the busy status of the current connection system of the terminal device.

In embodiments of the present disclosure, the terminal device may use the second communication card to send the RRC resume request message with the resume cause information element excluded to the access network device, so that the access network device may determine, according to the RRC resume request message with the resume cause information element excluded, the current connection system of the terminal device is in the busy status, reducing waste of paging resources.

As another example, after receiving the paging request, the terminal device may determine whether the current connection system is in the busy status. In a case that the current connection system is in the busy status, the terminal device may generate an RRC message carrying a busy indication, and send the RRC message carrying the busy indication to the access network device. After receiving the RRC message carrying the busy indication, the access network device may determine that the current connection system of the terminal device is in the busy status. It should be noted that the RRC message carrying the busy indication is used to indicate the busy status of the current connection system of the terminal device.

In embodiments of the present disclosure, the terminal device may use the second communication card to send the RRC message carrying the busy indication to the access network device, so that the access network device may determine, according to the RRC message carrying the busy indication, that the current connection system of the terminal device is in the busy status, reducing waste of paging resources.

According to the method for processing the paging of embodiments of the present disclosure, the paging request for the non-current connection system forwarded by the access network device is received, and in a case that it is determined that the current connection system of the terminal device is in the busy status, the RRC resume request message with the resume cause information element excluded is sent to the access network device or the busy indication RRC message is sent to the access network device. Thus, the access network device may learn that the current connection system of the terminal device is in the busy status according to the RRC resume request message with the resume cause information element excluded, or according to the busy indication RRC message, reducing waste of paging resources.

Embodiments of the present disclosure provide another method for processing a paging, and FIG. 2 is a schematic flowchart of another method for processing a paging according to an embodiment of the present disclosure. The method for processing the paging may be applied to a terminal device. The method for processing the paging may be executed alone, or may be executed in combination with any embodiment or implementations of embodiments in the present disclosure, or may be executed in combination with any technical solution in the related arts.

As shown in FIG. 2, the method for processing the paging may include the following steps 201 and 202.

In the step 201, a paging request for a non-current connection system forwarded by an access network device is received.

In the step 202, in response to a current connection system being in a busy status, an RRC resume request message with a resume cause information element excluded is sent to the access network device, the RRC resume request message includes a Message Authentication Code (MAC), and an input parameter required to generate the MAC includes a specified message content, an integrity key, a count value, a bearer identity, transmission direction information, and a busy token.

In an implementation of embodiments of the present disclosure, the RRC resume request message may include the Message Authentication Code (MAC), and the input parameter required to generate the MAC may include the specified message content, the integrity key, the count value, the bearer identity, the transmission direction information, and the busy token. For example, the input parameter required to generate the MAC may include the specified message content (MESSAGE), a 128-bit RRC integrity key named KEY (K_{RRCint}), a 32-bit count value (COUNT), a 5-bit bearer identity (BEARER) used to bear an identity, 1-bit transmission direction information (DIRECTION), where DIRECTION is 0 for an uplink and DIRECTION is 1 for a downlink, and the busy token.

The specified message content may be cell information of the access network device, that is, VarResumeMAC-Input or VarShortIMAC-Input.

Both VarResumeMAC-Input and VarShortIMAC-Input include the following information: identity information of a source cell, identity information of a target cell, and a Cell-Radio Network Temporary Identifier (C-RNTI) of the terminal device in the source cell.

The steps 201 to 202 may be implemented in any manner in various embodiments of the present disclosure, respectively, which are not limited by embodiments of the present disclosure and will not be described again.

According to the method for processing the paging of embodiments of the present disclosure, the paging request for the non-current connection system forwarded by the access network device is received, and in a case that it is determined that the current connection system of the terminal device is in the busy status, the RRC resume request message with the resume cause information element excluded is sent to the access network device. Thus, the access network device may learn, according to the RRC resume request message with the resume cause information element excluded, that the current connection system of the terminal device is in the busy status, reducing waste of paging resources.

It should be noted that the above implementations may be executed alone or in combination, which are not limited by embodiments of the present disclosure.

Embodiments of the present disclosure provide another method for processing a paging, and FIG. 3 is a schematic flowchart of another method for processing a paging according to an embodiment of the present disclosure. The method for processing the paging may be applied to a terminal device. The method for processing the paging may be executed alone, or may be executed in combination with any embodiment or implementations of embodiments in the present disclosure, or may be executed in combination with any technical solution in the related arts.

As shown in FIG. 3, the method for processing the paging may include the following steps 301 and 302.

In the step 301, a paging request for a non-current connection system forwarded by an access network device is received.

In the step 302, in response to a current connection system being in a busy status, an RRC resume request message with a resume cause information element excluded is sent to the access network device, and the RRC resume request message includes a Message Authentication Code (MAC); and according to an integrity key, a specified message content, a count value, a bearer identity, transmission direction information, and a busy token, message authentication code calculation is performed to generate the MAC.

In an implementation of embodiments of the present disclosure, in order to avoid the RRC resume request message from being tampered with and ensure the integrity of the RRC resume request message, the terminal device may perform, according to the integrity key, the count value, the bearer identity, the transmission direction information and the busy token, the message authentication code calculation for the specified message content to generate the MAC.

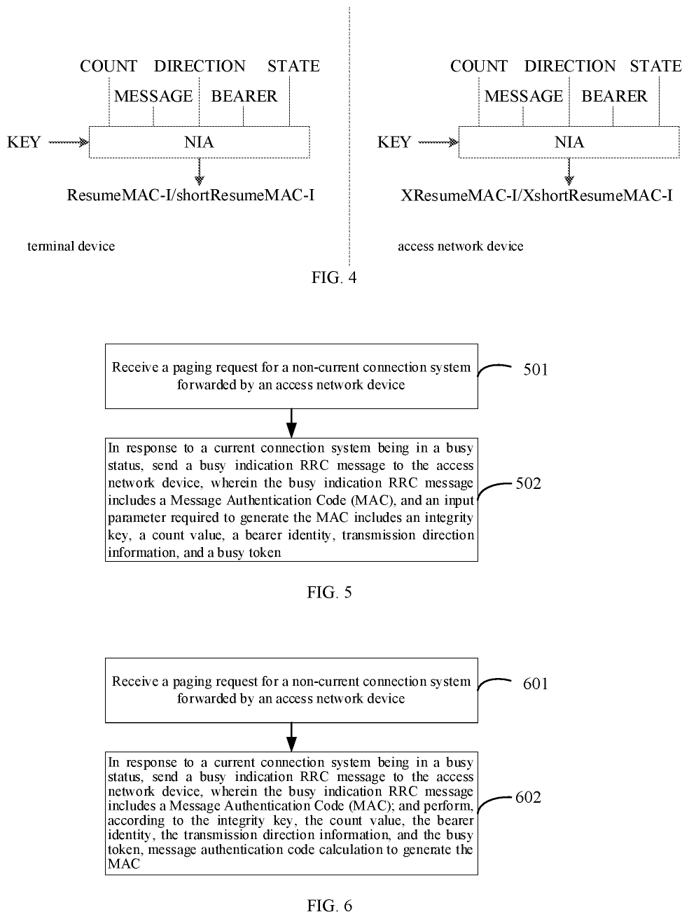

In some embodiments of the present disclosure, an input parameter of an integrity algorithm (NIA) include a 128-bit RRC integrity key named KEY (K_{RRCint}), a 32-bit count value (COUNT), a 5-bit bearer identity (BEARER) used to bear an identity, 1-bit transmission direction information (DIRECTION), the busy token and the specified message content (MESSAGE). For example, referring to FIG. 4, STATE refers to the busy token, which is an additional input parameter used to calculate the MAC. The terminal device may use the integrity algorithm NIA to calculate the 32-bit MAC. For example, the generated MAC may be ResumeMAC-I/shortResumeMAC-I in FIG. 4.

The steps 301 to 302 may be implemented in any manner in various embodiments of the present disclosure, respectively, which are not limited by embodiments of the present disclosure and will not be described again.

According to the method for processing the paging of embodiments of the present disclosure, the paging request for the non-current connection system forwarded by the access network device is received, and in a case that it is determined that the current connection system of the terminal device is in the busy status, the RRC resume request message with the resume cause information element excluded is sent to the access network device. Thus, the access network device may learn, according to the RRC resume request message with the resume cause information element excluded, that the current connection system of the terminal device is in the busy status, reducing waste of paging resources.

It should be noted that the above implementations may be executed alone or in combination, which are not limited by embodiments of the present disclosure.

Embodiments of the present disclosure provide another method for processing a paging, and FIG. 5 is a schematic flowchart of another method for processing a paging according to an embodiment of the present disclosure. The method for processing the paging may be applied to a terminal device. The method for processing the paging may be executed alone, or may be executed in combination with any embodiment or implementations of embodiments in the present disclosure, or may be executed in combination with any technical solution in the related arts.

As shown in FIG. 5, the method for processing the paging may include the following steps 501 and 502.

In the step 501, a paging request for a non-current connection system forwarded by an access network device is received.

In the step 502, in response to a current connection system being in a busy status, a busy indication RRC message is sent to the access network device, the busy indication RRC message includes a Message Authentication Code (MAC), and an input parameter required to generate the MAC includes an integrity key, a count value, a bearer identity, transmission direction information, and a busy token.

In an implementation of embodiments of the present disclosure, the busy indication RRC message may include the Message Authentication Code (MAC), and the input parameter required to generate the MAC may include the integrity key, the count value, the bearer identity, the transmission direction information, and the busy Token. For example, the input parameter required to generate the MAC may include a 128-bit RRC integrity key named KEY (K_{RRCint}), a 32-bit count value (COUNT), a 5-bit bearer identity (BEARER) used to bear an identity, 1-bit transmission direction information (DIRECTION), where DIRECTION is 0 for an uplink and DIRECTION is 1 for a downlink, and the busy token (BUSY_Token).

The steps 501 to 502 may be implemented in any manner in various embodiments of the present disclosure, respectively, which are not limited by embodiments of the present disclosure and will not be described again.

According to the method for processing the paging of embodiments of the present disclosure, the paging request for the non-current connection system forwarded by the access network device is received, and in a case that it is determined that the current connection system of the terminal device is in the busy status, the busy indication RRC message is sent to the access network device. Thus, the access network device may learn that the current connection system of the terminal device is in the busy status according to the busy indication RRC message, reducing waste of paging resources.

It should be noted that the above implementations may be executed alone or in combination, which are not limited by embodiments of the present disclosure.

Embodiments of the present disclosure provide another method for processing a paging, and FIG. 6 is a schematic flowchart of another method for processing a paging according to an embodiment of the present disclosure. The method for processing the paging may be applied to a terminal device. The method for processing the paging may be executed alone, or may be executed in combination with any embodiment or implementations of embodiments in the present disclosure, or may be executed in combination with any technical solution in the related arts.

As shown in FIG. 6, the method for processing the paging may include the following steps 601 and 602.

In the step 601, a paging request for a non-current connection system forwarded by an access network device is received.

In the step 602, in response to a current connection system being in a busy status, a busy indication RRC message is sent to the access network device, and the busy indication RRC message includes a Message Authentication Code (MAC); and according to an integrity key, a count value, a bearer identity, transmission direction information, and a busy token, message authentication code calculation is performed to generate the MAC.

In an implementation of embodiments of the present disclosure, in order to avoid the busy token from being tampered and ensure the integrity of the busy token, the message authentication code calculation is performed for the busy token according to the integrity key, the count value, the bearer identity, and the transmission direction information.

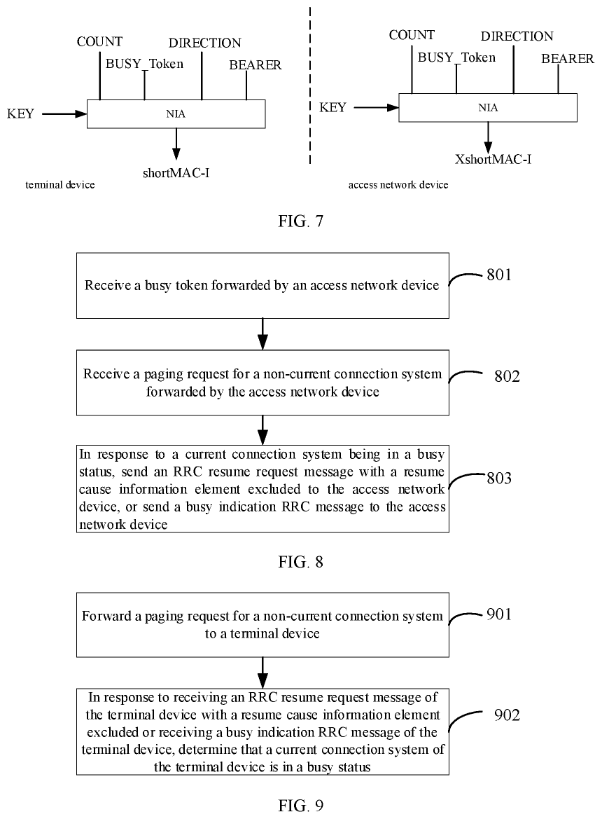

In some embodiments of the present disclosure, an input parameter of an integrity algorithm (NIA) include a 128-bit RRC integrity key named KEY (K_{RRCint}), a 32-bit count value (COUNT), a 5-bit bearer identity (BEARER) used to bear an identity, 1-bit transmission direction information (DIRECTION), and the busy token (BUSY_Token). For example, referring to FIG. 7, the terminal device may use the integrity algorithm NIA to calculate the 32-bit MAC. For example, the generated MAC may be shortMAC-I in FIG. 7.

The steps 601 to 602 may be implemented in any manner in various embodiments of the present disclosure, respectively, which are not limited by embodiments of the present disclosure and will not be described again.

According to the method for processing the paging of embodiments of the present disclosure, the paging request for the non-current connection system forwarded by the access network device is received, and in a case that it is determined that the current connection system of the terminal device is in the busy status, the busy indication RRC message is sent to the access network device. Thus, the access network device may learn that the current connection system of the terminal device is in the busy status according to the busy indication RRC message, reducing waste of paging resources.

It should be noted that the above implementations may be executed alone or in combination, which are not limited by embodiments of the present disclosure.

Embodiments of the present disclosure provide another method for processing a paging, and FIG. 8 is a schematic flowchart of another method for processing a paging according to an embodiment of the present disclosure. The method for processing the paging may be applied to a terminal device. The method for processing the paging may be executed alone, or may be executed in combination with any embodiment or implementations of embodiments in the present disclosure, or may be executed in combination with any technical solution in the related arts.

As shown in FIG. 8, the method for processing the paging may include the following steps 801 to 803.

In the step 801, a busy token forwarded by an access network device is received.

In embodiments of the present disclosure, the busy token may be sent by a core network device to the terminal device via the access network device.

In the step 802, a paging request for a non-current connection system forwarded by the access network device is received.

In the step 803, in response to a current connection system being in a busy status, an RRC resume request message with a resume cause information element excluded is sent to the access network device, or a busy indication RRC message is sent to the access network device.

The steps 802 to 803 may be implemented in any manner in various embodiments of the present disclosure, respectively, which are not limited by embodiments of the present disclosure and will not be described again.

According to the method for processing the paging of embodiments of the present disclosure, the paging request for the non-current connection system forwarded by the access network device is received, and in a case that it is determined that the current connection system of the terminal device is in the busy status, the RRC resume request message with the resume cause information element excluded is sent to the access network device or the busy indication RRC message is sent to the access network device. Thus, the access network device may learn that the current connection system of the terminal device is in the busy status according to the RRC resume request message with the resume cause information element excluded, or according to the busy indication RRC message, reducing waste of paging resources.

It should be noted that the above implementations may be executed alone or in combination, which are not limited by embodiments of the present disclosure.

Embodiments of the present disclosure provide another method for processing a paging, and FIG. 9 is a schematic flowchart of another method for processing a paging according to an embodiment of the present disclosure. The method for processing the paging may be performed by an access network device.

As shown in FIG. 9, the method for processing the paging may include the following steps 901 to 902

In the step 901, a paging request for a non-current connection system is forwarded to a terminal device.

The terminal device is equipped with a first communication card and a second communication card. The terminal device uses the first communication card to communicate with the current connection system, and the terminal device uses the second communication card to communicate with the non-current connection system.

In embodiments of the present disclosure, the current connection system refers to a system corresponding to a network that the terminal device currently accesses to, and the system is in a connection mode with the terminal device. The non-current connection system refers to a system corresponding to a network that the terminal device does not currently access to, and the system is in an idle mode with the terminal device. In the present disclosure, in order to facilitate the differentiation of different communication cards in the terminal device, a communication card in the terminal device that communicates with the current connection system may be called the first communication card, and a communication card in the terminal device that communicates with the non-current connection system may be called the second communication card.

In embodiments of the present disclosure, the terminal device may use the second communication card to receive the paging request for the non-current connection system forwarded by the access network device, and the paging request is used to page the terminal device.

In some embodiments of the present disclosure, a core network device of the non-current connection system may send the paging request to the terminal device via the access network device. Correspondingly, the terminal device may use the second communication card to receive the paging request forwarded by the access network device which is sent by the core network device of the non-current connection system.

In the step 902, in response to receiving an RRC resume request message of the terminal device with a resume cause information element excluded, or receiving a busy indication RRC message of the terminal device, it is determined that a current connection system of the terminal device is in a busy status.

As an example, after receiving the paging request, the terminal device may determine whether the current connection system is in the busy status. In a case that the current connection system is in the busy status, the terminal device may generate the RRC resume request message (RRCResumeRequest) with the resume cause information element excluded, and send the RRC resume request message to the access network device. After receiving the RRC resume request message, the access network device may determine that the current connection system of the terminal device is in the busy status. It should be noted that the RRC resume request message with the resume cause information element excluded is used to indicate the busy status of the current connection system of the terminal device.

In embodiments of the present disclosure, the terminal device may use the second communication card to send the RRC resume request message with the resume cause information element excluded to the access network device, so that the access network device may determine, according to the RRC resume request message with the resume cause information element excluded, the current connection system of the terminal device is in the busy status, reducing waste of paging resources.

As another example, after receiving the paging request, the terminal device may determine whether the current connection system is in the busy status. In a case that the current connection system is in the busy status, the terminal device may generate an RRC message carrying a busy indication, and send the RRC message carrying the busy indication to the access network device. After receiving the RRC message carrying the busy indication, the access network device may determine that the current connection system of the terminal device is in the busy status. It should be noted that the RRC message carrying the busy indication is used to indicate the busy status of the current connection system of the terminal device.

In embodiments of the present disclosure, the terminal device may use the second communication card to send the RRC message carrying the busy indication to the access network device, so that the access network device may determine, according to the RRC message carrying the busy indication, that the current connection system of the terminal device is in the busy status, reducing waste of paging resources.

It should be noted that the explanation of the method for processing the paging performed by the terminal device in any of embodiments of FIGS. 1 to 8 is also applicable to the method for processing the paging performed by the access network device in embodiments of the present disclosure, with the similar implementation principle, which will not be described in detail here.

According to the method for processing the paging of embodiments of the present disclosure, the paging request for the non-current connection system is forwarded to the terminal device, and in a case that the RRC resume request message of the terminal device with the resume cause information element excluded or the busy indication RRC message of the terminal device is received, it is determined that the current connection system of the terminal device is in the busy status. Thus, the access network device may quickly learn that the current connection system of the terminal device is in the busy status according to the RRC resume request message or the busy indication RRC message, reducing waste of paging resources.

It should be noted that the above implementations may be executed alone or in combination, which are not limited by embodiments of the present disclosure.

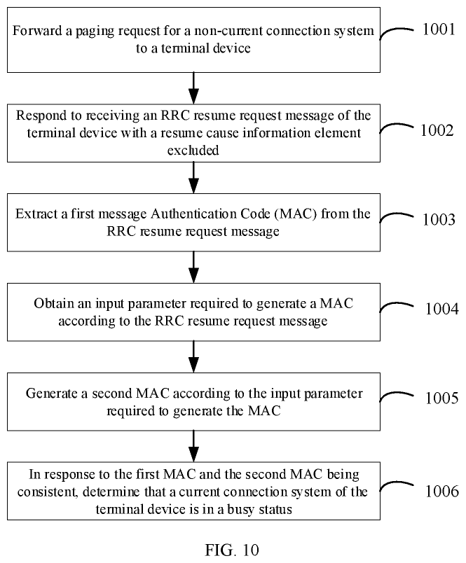

Embodiments of the present disclosure provide another method for processing a paging, and FIG. 10 is a schematic flowchart of another method for processing a paging according to an embodiment of the present disclosure. The method for processing the paging may be performed by an access network device.

As shown in FIG. 10, the method for processing the paging may include the following steps 1001 to 1006.

In the step 1001, a paging request for a non-current connection system is forwarded to a terminal device.

In the step 1002, receiving an RRC resume request message of the terminal device with a resume cause information element excluded is responded to.

In the step 1003, a first Message Authentication Code (MAC) is extracted from the RRC resume request message.

In an implementation of embodiments of the present disclosure, the RRC resume request message includes the first Message Authentication Code (MAC), and the access network device may extract the first Message Authentication Code (MAC) from the RRC resume request message. For example, the first Message Authentication Code (MAC) may be ResumeMAC-I/shortResumeMAC-I in FIG. 4.

In the step 1004, an input parameter required to generate the MAC is obtained according to the RRC resume request message.

In an implementation of embodiments of the present disclosure, the access network device may obtain the input parameter required to generate the MAC according to the RRC resume request message. The input parameter required to generate the MAC may include a specified message content, an integrity key, a count value, a bearer identity, transmission direction information, and a busy token.

In the step 1005, a second MAC is generated according to the input parameter required to generate the MAC.

Furthermore, the second MAC is generated according to the input parameter required to generate the MAC. For example, the second MAC may be XResumeMAC-I/XshortResumeMAC-I in FIG. 4.

In the step 1006, in response to the first MAC and the second MAC being consistent, it is determined that a current connection system of the terminal device is in a busy status.

Furthermore, the access network device may determine the busy status of the current connection system of the terminal device according to the matching of the first MAC and the second MAC.

In some embodiments of the present disclosure, in a case that the first MAC and the second MAC are consistent, the access network device may determine that the current connection system of the terminal device is in the busy status, and in a case that the first MAC and the second MAC are inconsistent, the access network device cannot determine whether the current connection system of the terminal device is in the busy status.

According to the method for processing the paging of embodiments of the present disclosure, the paging request for the non-current connection system is forwarded to the terminal device, and in a case that the RRC resume request message of the terminal device with the resume cause information element excluded is received, it is determined that the current connection system of the terminal device is in the busy status. Thus, the access network device may learn that the current connection system of the terminal device is in the busy status according to the RRC resume request message, reducing waste of paging resources.

It should be noted that the explanation of the method for processing the paging performed by the terminal device in any of embodiments of FIGS. 1 to 8 is also applicable to the method for processing the paging performed by the access network device in embodiments of the present disclosure, with the similar implementation principle, which will not be described in detail here.

It should be noted that the above implementations may be executed alone or in combination, which are not limited by embodiments of the present disclosure.

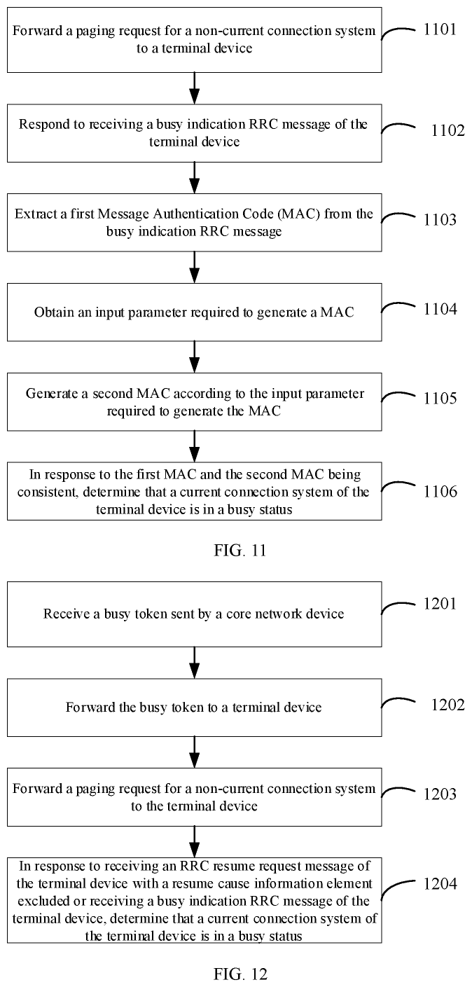

Embodiments of the present disclosure provide another method for processing a paging, and FIG. 11 is a schematic flowchart of another method for processing a paging according to an embodiment of the present disclosure. The method for processing the paging may be performed by an access network device.

As shown in FIG. 11, the method for processing the paging may include the following steps 1101 to 1106.

In the step 1101, a paging request for a non-current connection system is forwarded to a terminal device.

In the step 1102, receiving a busy indication RRC message of the terminal device is responded to.

In the step 1103, a first Message Authentication Code (MAC) is extracted from the busy indication RRC message.

In an implementation of embodiments of the present disclosure, the access network device may extract the first Message Authentication Code (MAC) from the busy indication RRC message. The first Message Authentication Code (MAC) is a MAC generated by the access network device using an integrity algorithm and according to an input parameter required to generate the MAC.

In the step 1104, the input parameter required to generate the MAC is obtained.

In an implementation of embodiments of the present disclosure, the access network device may obtain the input parameter required to generate the MAC from the busy indication RRC message, and the input parameter required to generate the MAC include an integrity key, a count value, a bearer identity, transmission direction information, and a busy token.

In the step 1105, a second MAC is generated according to the input parameter required to generate the MAC.

Next, the second MAC is generated according to the input parameter required to generate the MAC. For example, the second MAC may be XshortMAC-I in FIG. 7.

In the step 1106, in response to the first MAC and the second MAC being consistent, it is determined that a current connection system of the terminal device is in a busy status.

Furthermore, the access network device may determine the busy status of the current connection system of the terminal device according to the matching of the first MAC and the second MAC.

In some embodiments of the present disclosure, in a case that the first MAC and the second MAC are consistent, the access network device may determine that the current connection system of the terminal device is in the busy status, and in a case that the first MAC and the second MAC are inconsistent, the access network device cannot determine whether the current connection system of the terminal device is in the busy status.

According to the method for processing the paging of embodiments of the present disclosure, the paging request for the non-current connection system is forwarded to the terminal device, and in a case that the busy indication RRC message of the terminal device is received, it is determined that the current connection system of the terminal device is in the busy status. Thus, the access network device may learn that the current connection system of the terminal device is in the busy status according to the busy indication RRC message, reducing waste of paging resources.

It should be noted that the explanation of the method for processing the paging performed by the terminal device in any of embodiments of FIGS. 1 to 8 is also applicable to the method for processing the paging performed by the access network device in embodiments of the present disclosure, with the similar implementation principle, which will not be described in detail here.

It should be noted that the above implementations may be executed alone or in combination, which are not limited by embodiments of the present disclosure.

Embodiments of the present disclosure provide another method for processing a paging, and FIG. 12 is a schematic flowchart of another method for processing a paging according to an embodiment of the present disclosure. The method for processing the paging may be performed by an access network device.

As shown in FIG. 12, the method for processing the paging may include the following steps 1201 to 1204.

In the step 1201, a busy token sent by a core network device is received.

As an implementation of the present disclosure, a terminal device context sent by the core network device is received, and the terminal device context includes the busy token.

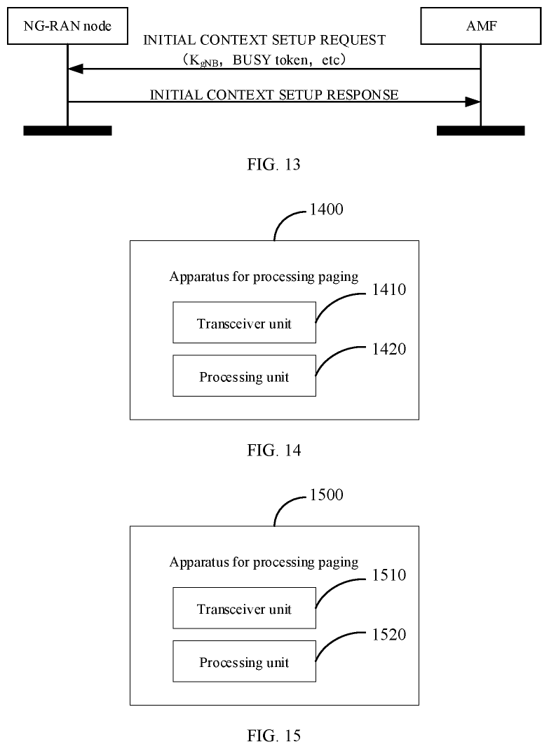

That is to say, as shown in FIG. 13, the access network device (such as a NG-RAN node) initiates a context setup procedure, and the core network device (such as an AMF) sends the terminal device context to the access network device. The terminal device context may include but is not limited to a security key (KgNB), a busy token (BUSY token), etc.

In the step 1202, the busy token is forwarded to a terminal device.

In the step 1203, a paging request for a non-current connection system is forwarded to the terminal device.

In the step 1204, in response to receiving an RRC resume request message of the terminal device with a resume cause information element excluded or receiving a busy indication RRC message of the terminal device, it is determined that a current connection system of the terminal device is in a busy status.

It should be noted that the explanation of the method for processing the paging performed by the terminal device in any of embodiments of FIGS. 1 to 8 is also applicable to the method for processing the paging performed by the access network device in embodiments of the present disclosure, with the similar implementation principle, which will not be described in detail here.

According to the method for processing the paging of embodiments of the present disclosure, the paging request for the non-current connection system is forwarded to the terminal device, and in a case that the RRC resume request message of the terminal device with the resume cause information element excluded or the busy indication RRC message of the terminal device is received, it is determined that the current connection system of the terminal device is in the busy status. Thus, the access network device may quickly learn that the current connection system of the terminal device is in the busy status according to the RRC resume request message or the busy indication RRC message, reducing waste of paging resources.

It should be noted that the above implementations may be executed alone or in combination, which are not limited by embodiments of the present disclosure.

Corresponding to the method for processing the paging provided by embodiments of FIGS. 1 to 8, the present disclosure further provides an apparatus for processing a paging. Since the apparatus for processing the paging provided by embodiments of the present disclosure corresponds to the method for processing the paging provided by embodiments of FIGS. 1 to 8, implementations of the method for processing the paging are also applicable to the apparatus for processing the paging provided by embodiments of the present disclosure, which will not be described in detail in embodiments of the present disclosure.

FIG. 14 is a schematic structural diagram of an apparatus for processing a paging according to an embodiment of the present disclosure.

As shown in FIG. 14, the apparatus for processing the paging 1400 is performed by a terminal device, and may include: a transceiver unit 1410 and a processing unit 1420.

The transceiver unit 1410 is configured to receive a paging request for a non-current connection system forwarded by an access network device. The processing unit 1420 is configured to, in response to a current connection system being in a busy status, send an RRC resume request message with a resume cause information element excluded to the access network device, or send a busy indication RRC message to the access network device. The terminal device is equipped with a first communication card and a second communication card, the terminal device is in communication with the current connection system through the first communication card, and the terminal device is in communication with the non-current connection system through the second communication card.

In some embodiments of the present disclosure, the RRC resume request message includes a Message Authentication Code (MAC), and an input parameter required to generate the MAC includes a specified message content, an integrity key, a count value, a bearer identity, transmission direction information, and a busy token.

In some embodiments of the present disclosure, the processing unit is further configured to perform, according to the integrity key, the specified message content, the count value, the bearer identity, the transmission direction information, and the busy token, message authentication code calculation to generate the MAC.

In some embodiments of the present disclosure, the busy indication RRC message includes a Message Authentication Code (MAC), and an input parameter required to generate the MAC includes an integrity key, a count value, a bearer identity, transmission direction information, and a busy token.

In some embodiments of the present disclosure, the processing unit is further configured to perform, according to the integrity key, the count value, the bearer identity, the transmission direction information, and the busy token, message authentication code calculation to generate the MAC.

In some embodiments of the present disclosure, the transceiver unit is further configured to receive a busy token forwarded by the access network device.

According to the apparatus for processing the paging of embodiments of the present disclosure, the paging request for the non-current connection system forwarded by the access network device is received, and in a case that it is determined that the current connection system of the terminal device is in the busy status, the RRC resume request message with the resume cause information element excluded or the busy indication RRC message is sent to the access network device. Thus, the access network device may learn that the current connection system of the terminal device is in the busy status according to the RRC resume request message with the resume cause information element excluded, or according to the busy indication RRC message, reducing waste of paging resources.

It should be noted that the above implementations may be executed alone or in combination, which are not limited by embodiments of the present disclosure.

Corresponding to the method for processing the paging provided by embodiments of FIGS. 9 to 13, the present disclosure further provides another apparatus for processing a paging. Since the apparatus for processing the paging provided by embodiments of the present disclosure corresponds to the method for processing the paging provided by embodiments of FIGS. 9 to 13, implementations of the method for processing the paging are also applicable to the apparatus for processing the paging provided by embodiments of the present disclosure, which will not be described in detail in embodiments of the present disclosure.

FIG. 15 is a schematic structural diagram of another apparatus for processing a paging according to an embodiment of the present disclosure.

As shown in FIG. 15, the apparatus for processing the paging 1500 is performed by an access network device, and the apparatus for processing the paging 1500 includes: a transceiver unit 1510 and a processing unit 1520.

The transceiver unit 1510 is configured to forward a paging request for a non-current connection system to a terminal device. The processing unit 1520 is configured to, in response to receiving an RRC resume request message of the terminal device with a resume cause information element excluded or receiving a busy indication RRC message of the terminal device, determine that a current connection system of the terminal device is in a busy status.

In some embodiments of the present disclosure, the processing unit 1520 is further configured to extract a first Message Authentication Code (MAC) from the RRC resume request message; obtain an input parameter required to generate a MAC according to the RRC resume request message; generate a second MAC according to the input parameter required to generate the MAC; and in response to the first MAC and the second MAC being consistent, determine that the current connection system of the terminal device is in the busy status.

In some embodiments of the present disclosure, the input parameter required to generate the MAC includes a specified message content, an integrity key, a count value, a bearer identity, transmission direction information, and a busy token.

In some embodiments of the present disclosure, the processing unit 1520 is further configured to extract a first Message Authentication Code (MAC) from the busy indication RRC message; obtain an input parameter required to generate a MAC; generate a second MAC according to the input parameter required to generate the MAC; and in response to the first MAC and the second MAC being consistent, determine that the current connection system of the terminal device is in the busy status.

In some embodiments of the present disclosure, he input parameter required to generate the MAC includes an integrity key, a count value, a bearer identity, transmission direction information, and a busy token.

In some embodiments of the present disclosure, the transceiver unit 1510 is further configured to receive a busy token sent by a core network device; and forward the busy token to the terminal device.

In some embodiments of the present disclosure, the transceiver unit is further configured to receive a terminal device context sent by the core network device, and the terminal device context includes the busy token.

According to the apparatus for processing the paging of embodiments of the present disclosure, the paging request for the non-current connection system is forwarded to the terminal device, and in a case that the RRC resume request message of the terminal device with the resume cause information element excluded is received, or the busy indication RRC message of the terminal device is received, it is determined that the current connection system of the terminal device is in the busy status. Thus, the access network device may quickly learn that the current connection system of the terminal device is in the busy status according to the RRC resume request message or the busy indication RRC message, reducing waste of paging resources.

It should be noted that the above implementations may be executed alone or in combination, which are not limited by embodiments of the present disclosure.

In order to implement the above embodiments, the present disclosure provides an apparatus for processing a paging, including a processor and a memory. A computer program is stored in the memory, and the processor performs the computer program stored in the memory to cause the apparatus to execute the method described in embodiments of FIGS. 1 to 8.

In order to implement the above embodiments, the present disclosure provides another apparatus for processing a paging, including a processor and a memory. A computer program is stored in the memory, and the processor performs the computer program stored in the memory to cause the apparatus to execute the method described in embodiments of FIGS. 9 to 13.

In order to implement the above embodiments, the present disclosure provides an apparatus for processing a paging, including a processor and an interface circuit. The interface circuit is configured to receive code instructions and transmit them to the processor; and the processor is configured to run the code instructions to perform the method described in embodiments of FIGS. 1 to 8.

In order to implement the above embodiments, the present disclosure provides another apparatus for processing a paging, including a processor and an interface circuit. The interface circuit is configured to receive code instructions and transmit them to the processor; and the processor is configured to run the code instructions to perform the method described in embodiments of FIGS. 9 to 13.

In order to implement the above embodiments, the present disclosure provides a computer-readable storage medium having instructions stored thereon which, when executed, cause the method described in embodiments of FIGS. 1 to 8 to be implemented.

In order to implement the above embodiments, the present disclosure provides a computer-readable storage medium having instructions stored thereon which, when executed, cause the method described in embodiments of FIGS. 9 to 13 to be implemented.

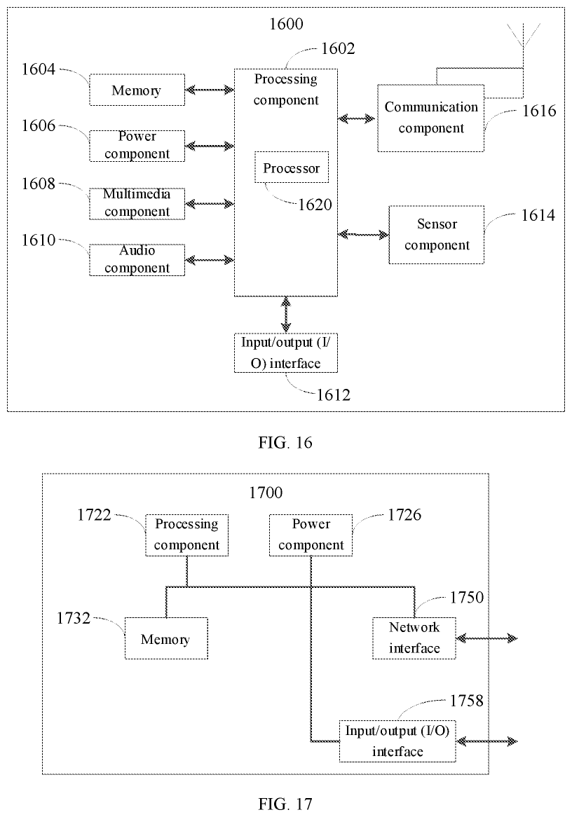

FIG. 16 is a block diagram of a terminal device according to an embodiment of the present disclosure. For example, the terminal device 1600 may be a mobile phone, a computer, a digital broadcast user device, a messaging device, a gaming console, a tablet device, a medical device, an exercise device, a personal digital assistant, etc.

Referring to FIG. 16, the terminal device 1600 may include at least one following component: a processing component 1602, a memory 1604, a power component 1606, a multimedia component 1608, an audio component 1610, an input/output (I/O) interface 1612, a sensor component 1614, and a communication component 1616.

The processing component 1602 typically controls overall operations of the terminal device 1600, such as the operations associated with display, telephone calls, data communications, camera operations, and recording operations. The processing component 1602 may include at least one processor 1620 to execute instructions to perform all or part of the steps in the above described methods. Moreover, the processing component 1602 may include at least one module which facilitates the interaction between the processing component 1602 and other components. For instance, the processing component 1602 may include a multimedia module to facilitate the interaction between the multimedia component 1608 and the processing component 1602.

The memory 1604 is configured to store various types of data to support the operation of the terminal device 1600. Examples of such data include instructions for any applications or methods operated on the terminal device 1600, contact data, phonebook data, messages, pictures, video, etc. The memory 1604 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1606 provides power to various components of the terminal device 1600. The power component 1606 may include a power management system, at least one power source, and any other components associated with the generation, management, and distribution of power in the terminal device 1600.

The multimedia component 1608 includes a screen providing an output interface between the terminal device 1600 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a wake-up time and a pressure associated with the touch or swipe action. In some embodiments, the multimedia component 1608 includes a front camera and/or a rear camera. The front camera and the rear camera may receive an external multimedia datum while the terminal device 1600 is in an operation mode, such as a photographing mode or a video mode. Each of the front camera and the rear camera may be a fixed optical lens system or have focus and optical zoom capability.

The audio component 1610 is configured to output and/or input audio signals. For example, the audio component 1610 includes a microphone (MIC) configured to receive an external audio signal when the terminal device 1600 is in an operation mode, such as a call mode, a recording mode, and a voice recognition mode. The received audio signal may be further stored in the memory 1604 or transmitted via the communication component 1616. In some embodiments, the audio component 1610 further includes a speaker to output audio signals.

The I/O interface 1612 provides an interface between the processing component 1602 and peripheral interface modules, such as a keyboard, a click wheel, buttons, and the like. The buttons may include, but are not limited to, a home button, a volume button, a starting button, and a locking button.

The sensor component 1614 includes at least one sensor to provide status assessments of various aspects of the terminal device 1600. For instance, the sensor component 1614 may detect an open/closed status of the terminal device 1600, relative positioning of components, e.g., the display and the keypad, of the terminal device 1600, a change in position of the terminal device 1600 or a component of the terminal device 1600, a presence or absence of user contact with the terminal device 1600, an orientation or an acceleration/deceleration of the terminal device 1600, and a change in temperature of the terminal device 1600. The sensor component 1614 may include a proximity sensor configured to detect the presence of nearby objects without any physical contact. The sensor component 1614 may also include a light sensor, such as a CMOS or CCD image sensor, for use in imaging applications. In some embodiments, the sensor component 1614 may also include an accelerometer sensor, a gyroscope sensor, a magnetic sensor, a pressure sensor, or a temperature sensor.

The communication component 1616 is configured to facilitate communication, wired or wirelessly, between the terminal device 1600 and other devices. The terminal device 1600 may access a wireless network based on a communication standard, such as WiFi, 2G, or 3G, or a combination thereof. In an embodiment, the communication component 1616 receives a broadcast signal or broadcast associated information from an external broadcast management system via a broadcast channel. In an embodiment, the communication component 1616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In embodiments of the present disclosure, the terminal device 1600 may be implemented with at least one application specific integrated circuit (ASIC), digital signal processor (DSP), digital signal processing device (DSPD), programmable logic device (PLD), field programmable gate array (FPGA), controller, micro-controller, microprocessor, or other electronic components, for performing the method shown in any of the above-mentioned FIGS. 1 to 8.

In embodiments of the present disclosure, there is further provided a non-transitory computer readable storage medium including instructions, such as the memory 1604 including instructions, the above instructions may be executed by the processor 1620 in the terminal device 1600 for performing the method shown in any of the above-mentioned FIGS. 1 to 8. For example, the non-transitory computer-readable storage medium may be a ROM, a Random Access Memory (RAM), a CD-ROM, a magnetic tape, a floppy disc, an optical data storage device, and the like.

As shown in FIG. 17, it is a schematic structural diagram of a network device according to an embodiment of the present disclosure. Referring to FIG. 17, the network device 1700 includes a processing component 1722, which further includes at least one processor and a memory resource represented by a memory 1732 for storing instructions executable by the processing component 1722, such as an application program. The application program stored in the memory 1732 may include one or more modules, each corresponding to a set of instructions. In addition, the processing component 1722 is configured to execute the instructions to execute any of the aforementioned methods applied in the network device, such as the method shown in any one of FIGS. 9 to 13.

The network device 1700 may further include: a power component 1726 configured to perform power management of the network device 1700, a wired or wireless network interface 1750 configured to connect the network device 1700 to the network, and an input/output (I/O) interface 1758. The network device 1700 may operate an operating system stored in the memory 1732, such as Windows Server™, Mac OS X™, Unix™, Linux™, FreeBSD™, or the like.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

In order to implement the above embodiments, embodiments of the present disclosure further provide a communication device. The communication device may be a network device, or may be a terminal device, or may be a chip, a chip system, a processor, or the like that supports the network device to implement the above method, or may be a chip, a chip system, a processor, or the like that supports the terminal device to implement the above method. The communication device may be configured to implement the method described in any of the above method embodiments. For details, reference may be made to the description in the above method embodiments.

The communications device may include one or more processors. The processor may be a general-purpose processor, a special-purpose processor, or the like. For example, the processor may be a baseband processor or a central processing unit. The baseband processor may be configured to process a communications protocol and communications data. The central processing unit may be configured to: control the communications device (for example, the base station, the baseband chip, the terminal device, a terminal device chip, a DU, or a CU), execute a computer program, and process data of a computer program.

In some embodiments of the present disclosure, the communications device may further include one or more memories. The memory may store a computer program, and the processor executes the computer program to cause the communication device to execute the method described in the foregoing method embodiments. In some embodiments of the present disclosure, the memory may further store data. The communication device and the memory may be disposed separately, or may be integrated together.

In some embodiments of the present disclosure, the communications device may further include a transceiver and an antenna. The transceiver may be referred to as a transceiver unit, a transceiver machine, a transceiver circuit, or the like, and is configured to implement receiving and sending functions. The transceiver may include a receiver and a transmitter. The receiver may be referred to as a receiver machine or a receiving circuit, etc., and is configured to implement the receiving function, and the transmitter may be referred to as a transmitter machine or a transmitting circuit, etc., and is configured to implement the transmitting function.

In some embodiments of the present disclosure, the communications device may further include one or more interface circuits. The interface circuit is configured to receive code instructions and transmit them to the processor, and the processor runs the code instructions to cause the communication device to perform the method described in any of the foregoing method embodiments.

In an implementation, the processor may include a transceiver configured to implement receiving and sending functions. For example, the transceiver may be a transceiver circuit, an interface, or an interface circuit. A transceiver circuit, an interface, or an interface circuit configured to implement the receiving and sending functions may be separated, or may be integrated together. The transceiver circuit, the interface, or the interface circuit may be configured to read and write code/data; or the transceiver circuit, the interface, or the interface circuit may be configured to transmit or transfer a signal.

In an implementation, the processor may store a computer program, and the computer program runs on the processor, which can cause the communication device to perform the method described in any of the above method embodiments. The computer program may be embedded in the processor, in which case the processor may be implemented in hardware.

In an implementation, the communication device may include a circuit, and the circuit may implement the sending function, the receiving function, or the communication function in the foregoing method embodiments. The processor and the transceiver described in the present disclosure may be implemented on an Integrated Circuit (IC), an analog IC, a Radio Frequency Integrated Circuit (RFIC), a hybrid signal IC, an Application Specific Integrated Circuit (ASIC), a Printed Circuit Board (PCB), an electronic device, or the like. The processor and the transceiver may also be manufactured by using various IC process technologies, for example, a Complementary Metal Oxide Semiconductor (CMOS), a nMetal-Oxide-Semiconductor (NMOS), a Positive Channel Metal Oxide Semiconductor (PMOS), a Bipolar Junction Transistor (BJT), a bipolar CMOS (BiCMOS), silicon germanium (SiGe), and gallium arsenide (GaAs).

The communications device in the foregoing embodiments may be a network device or a terminal device. However, a scope of the communications device described in the present disclosure is not limited thereto. The communications device may be an independent device or may be a part of a relatively large device. For example, the communications device may be:
(1) an independent Integrated Circuit (IC), a chip, a chip system, or a subsystem;
(2) a set including one or more ICs, and in some embodiments of the present disclosure, the IC set may further include a storage component configured to store data and a computer program;
(3) an ASIC, for example, a modem;
(4) a module that can be embedded in another device;
(5) a receiver, a terminal device, an intelligent terminal device, a cellular phone, a wireless device, a handheld phone, a mobile unit, a vehicle-mounted device, a network device, a cloud device, an artificial intelligence device, or the like; and
(6) other devices.

In a case that the communication device may be a chip or a chip system, the chip may include a processor and an interface. There may be one or more processors, and there may be a plurality of interfaces.

In some embodiments of the present disclosure, the chip further includes a memory, which is configured to store necessary computer programs and data.

A person skilled in the art may further understand that various illustrative logical blocks and steps that are listed in embodiments of the present disclosure may be implemented by using electronic hardware, computer software, or a combination thereof. Whether such a function is implemented by using hardware or software depends on particular applications and a design requirement of the entire system. A person skilled in the art may use various methods to implement the described functions for each particular application, but it should not be considered that such an implementation goes beyond the scope of embodiments of the present disclosure.

The present disclosure further provides a readable storage medium having instructions stored thereon which, when executed by a computer, implement a function in any one of the foregoing method embodiments.

The present disclosure further provides a computer program product which, when executed by a computer, implements a function in any one of the foregoing method embodiments.

All or some of the foregoing embodiments may be implemented by software, hardware, firmware, or any combination thereof. When software is used to implement the embodiments, all or some of the embodiments may be implemented in a form of computer program product. The computer program product includes one or more computer programs. When the computer programs are loaded and executed on a computer, the procedures or functions according to embodiments of the present disclosure are all or partially generated. The computer may be a general-purpose computer, a special-purpose computer, a computer network, or another programmable apparatus. The computer programs may be stored in a computer-readable storage medium or may be transmitted from one computer-readable storage medium to another computer-readable storage medium. For example, the computer programs may be transmitted from one website, computer, server, or data center to another website, computer, server, or data center in a wired (for example, a coaxial cable, an optical fiber, or a Digital Subscriber Line (DSL)) or wireless (for example, infrared, radio, and microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a high-density Digital Video Disc (DVD)), a semiconductor medium (for example, a Solid State Drive (SSD)), or the like.

In a first aspect, embodiments of the present disclosure provide a method for processing a paging, which is performed by a terminal device. The method includes: receiving a paging request for a non-current connection system forwarded by an access network device; and in response to a current connection system being in a busy status, sending an RRC resume request message with a resume cause information element excluded to the access network device, or sending a busy indication RRC message to the access network device, where the terminal device is equipped with a first communication card and a second communication card, the terminal device is in communication with the current connection system through the first communication card, and the terminal device is in communication with the non-current connection system through the second communication card.

In the technical solution, the paging request for the non-current connection system forwarded by the access network device is received, and in a case that it is determined that the current connection system of the terminal device is in the busy status, the RRC resume request message with the resume cause information element excluded is sent to the access network device or the busy indication RRC message is sent to the access network device. Thus, the access network device may learn that the current connection system of the terminal device is in the busy status according to the RRC resume request message with the resume cause information element excluded, or according to the busy indication RRC message, reducing waste of paging resources.

In some embodiments of the present disclosure, the RRC resume request message includes a Message Authentication Code (MAC), and an input parameter required to generate the MAC includes a specified message content, an integrity key, a count value, a bearer identity, transmission direction information, and a busy token.

In some embodiments of the present disclosure, the method further includes: performing, according to the integrity key, the specified message content, the count value, the bearer identity, the transmission direction information, and the busy token, message authentication code calculation to generate the MAC.

In some embodiments of the present disclosure, the busy indication RRC message includes a Message Authentication Code (MAC), and an input parameter required to generate the MAC includes an integrity key, a count value, a bearer identity, transmission direction information, and a busy token.

In some embodiments of the present disclosure, the method further includes: performing, according to the integrity key, the count value, the bearer identity, the transmission direction information, and the busy token, message authentication code calculation to generate the MAC.

In some embodiments of the present disclosure, before the receiving the paging request for the non-current connection system forwarded by the access network device, the method further includes: receiving a busy token forwarded by the access network device.

In a second aspect, embodiments of the present disclosure provide another method for processing a paging, which is performed by an access network device. The method includes: forwarding a paging request for a non-current connection system to a terminal device; and in response to receiving an RRC resume request message of the terminal device with a resume cause information element excluded or receiving a busy indication RRC message of the terminal device, determining that a current connection system of the terminal device is in a busy status.

In some embodiments of the present disclosure, the determining that the current connection system of the terminal device is in the busy status includes: extracting a first Message Authentication Code (MAC) from the RRC resume request message; obtaining an input parameter required to generate a MAC according to the RRC resume request message; generating a second MAC according to the input parameter required to generate the MAC; and in response to the first MAC and the second MAC being consistent, determining that the current connection system of the terminal device is in the busy status.

In some embodiments of the present disclosure, the input parameter required to generate the MAC includes a specified message content, an integrity key, a count value, a bearer identity, transmission direction information, and a busy token.

In some embodiments of the present disclosure, the determining that the current connection system of the terminal device is in the busy status includes: extracting a first Message Authentication Code (MAC) from the busy indication RRC message; obtaining an input parameter required to generate a MAC; generating a second MAC according to the input parameter required to generate the MAC; and in response to the first MAC and the second MAC being consistent, determining that the current connection system of the terminal device is in the busy status.

In some embodiments of the present disclosure, the input parameter required to generate the MAC includes an integrity key, a count value, a bearer identity, transmission direction information, and a busy token.

In some embodiments of the present disclosure, before the forwarding the paging request for the non-current connection system to the terminal device, the method further includes: receiving a busy token sent by a core network device; and forwarding the busy token to the terminal device.

In some embodiments of the present disclosure, the receiving the busy token sent by the core network device includes: receiving a terminal device context sent by the core network device, and the terminal device context includes the busy token.

In a third aspect, embodiments of the present disclosure provide an apparatus for processing a paging, which is performed by a terminal device. The apparatus includes: a transceiver unit, configured to receive a paging request for a non-current connection system forwarded by an access network device; and a processing unit, configured to, in response to a current connection system being in a busy status, send an RRC resume request message with a resume cause information element excluded to the access network device, or send a busy indication RRC message to the access network device, where the terminal device is equipped with a first communication card and a second communication card, the terminal device is in communication with the current connection system through the first communication card, and the terminal device is in communication with the non-current connection system through the second communication card.

In some embodiments of the present disclosure, the RRC resume request message includes a Message Authentication Code (MAC), and an input parameter required to generate the MAC includes a specified message content, an integrity key, a count value, a bearer identity, transmission direction information, and a busy token.

In some embodiments of the present disclosure, the processing unit is further configured to perform, according to the integrity key, the specified message content, the count value, the bearer identity, the transmission direction information, and the busy token, message authentication code calculation to generate the MAC.

In some embodiments of the present disclosure, the busy indication RRC message includes a Message Authentication Code (MAC), and an input parameter required to generate the MAC includes an integrity key, a count value, a bearer identity, transmission direction information, and a busy token.

In some embodiments of the present disclosure, the processing unit is further configured to perform, according to the integrity key, the count value, the bearer identity, the transmission direction information, and the busy token, message authentication code calculation to generate the MAC.

In some embodiments of the present disclosure, the transceiver unit is further configured to receive a busy token forwarded by the access network device. In a fourth aspect, embodiments of the present disclosure provide another apparatus for processing a paging, which is performed by an access network device. The apparatus includes: a transceiver unit, configured to forward a paging request for a non-current connection system to a terminal device; and a processing unit, configured to, in response to receiving an RRC resume request message of the terminal device with a resume cause information element excluded or receiving a busy indication RRC message of the terminal device, determine that a current connection system of the terminal device is in a busy status.

In some embodiments of the present disclosure, the processing unit is further configured to extract a first Message Authentication Code (MAC) from the RRC resume request message; obtain an input parameter required to generate a MAC according to the RRC resume request message; generate a second MAC according to the input parameter required to generate the MAC; and in response to the first MAC and the second MAC being consistent, determine that the current connection system of the terminal device is in the busy status.

In some embodiments of the present disclosure, the input parameter required to generate the MAC includes a specified message content, an integrity key, a count value, a bearer identity, transmission direction information, and a busy token.

In some embodiments of the present disclosure, the processing unit is further configured to extract a first Message Authentication Code (MAC) from the busy indication RRC message; obtain an input parameter required to generate a MAC; generate a second MAC according to the input parameter required to generate the MAC; and in response to the first MAC and the second MAC being consistent, determine that the current connection system of the terminal device is in the busy status.

In some embodiments of the present disclosure, the input parameter required to generate the MAC includes an integrity key, a count value, a bearer identity, transmission direction information, and a busy token.

In some embodiments of the present disclosure, the transceiver unit is further configured to receive a busy token sent by a core network device; and forward the busy token to the terminal device.

In some embodiments of the present disclosure, the transceiver unit is further configured to receive a terminal device context sent by the core network device, and the terminal device context includes the busy token.

In a fifth aspect, embodiments of the present disclosure provide another apparatus for processing a paging, including a processor and a memory. A computer program is stored in the memory, and the processor is configured to perform the computer program stored in the memory to cause the apparatus to execute the method described in embodiments of the first aspect of the present disclosure.

In a sixth aspect, embodiments of the present disclosure provide another apparatus for processing a paging, including a processor and a memory. A computer program is stored in the memory, and the processor is configured to perform the computer program stored in the memory to cause the apparatus to execute the method described in embodiments of the second aspect of the present disclosure.

In a seventh aspect, embodiments of the present disclosure provide another apparatus for processing a paging, including a processor and an interface circuit. The interface circuit is configured to receive code instructions and transmit them to the processor; and the processor is configured to run the code instructions to perform the method described in embodiments of the first aspect of the present disclosure.

In an eighth aspect, embodiments of the present disclosure provide another apparatus for processing a paging, including a processor and an interface circuit. The interface circuit is configured to receive code instructions and transmit them to the processor; and the processor is configured to run the code instructions to perform the method described in embodiments of the second aspect of the present disclosure.

In a ninth aspect, embodiments of the present disclosure provide a computer-readable storage medium having instructions stored thereon, which, when executed, cause the method described in embodiments of the first aspect of the present disclosure to be implemented.

In a tenth aspect, embodiments of the present disclosure provide another computer-readable storage medium having instructions stored thereon, which, when executed, cause the method described in embodiments of the second aspect of the present disclosure to be implemented.

In an eleventh aspect, embodiments of the present disclosure provide a computer program product which, when run on a computer, causes the computer to execute the method described in embodiments of the first aspect of the present disclosure.

In a twelfth aspect, embodiments of the present disclosure provide another computer program product which, when run on a computer, causes the computer to execute the method described in embodiments of the second aspect of the present disclosure.

A person of ordinary skill in the art may understand that various reference numerals such as “first” and “second” in the present disclosure are merely used for differentiation for ease of description, and are not used to limit the scope of embodiments of the present disclosure, or represent a sequence.

“At least one” in the present disclosure may also be described as one or more, and the plurality may be two, three, four or more, which are not limited by the present disclosure. In embodiments of the present disclosure, for a technical feature, “first”, “second”, “third”, “A”, “B”, “C”, “D” and the like are used for distinguishing technical features among this technical feature. There is no chronological order or no size order between the technical features described by “first”, “second”, “third”, “A”, “B”, “C”, and “D”.

The correspondences shown in the tables in the present disclosure may be configured, or may be predefined. Values of the information in the tables are merely examples, and other values may be configured. This is not limited in the present disclosure. When a correspondence between information and each parameter is configured, not all correspondences shown in the tables need to be configured. For example, in the tables in the present disclosure, correspondences shown in some rows may alternatively not be configured. For another example, proper transformation and adjustments such as splitting and combination may be performed based on the foregoing tables. Names of the parameters shown in titles of the foregoing tables may also be other names that can be understood by a communication device, and values or representation manners of the parameters may also be other values or representation manners that can be understood by the communications apparatus. During implementation of the foregoing tables, another data structure, such as an array, a queue, a container, a stack, a linear table, a pointer, a linked list, a tree, a graph, a structure, a class, a pile, or a hash table, may be used.

“Predefine” in the present disclosure may be understood as “define”, “define in advance”, “store”, “pre-store”, “pre-negotiate”, “pre-configure”, “solidify”, or “pre-burn”.

A person of ordinary skill in the art may be aware that, in combination with examples described in embodiments disclosed in this specification, units and algorithm operations may be implemented by electronic hardware or a combination of computer software and electronic hardware. Whether the functions are performed by hardware or software depends on a particular application and a design constraint of the technical solutions. A person skilled in the art may use different methods to implement the described functions for each particular application, but it should not be considered that such an implementation goes beyond the scope of the present disclosure.

A person skilled in the art may clearly understand that, for the purpose of convenient and brief description, for detailed working processes of the foregoing system, apparatus, and unit, reference may be made to corresponding processes in the foregoing method embodiments, and details are not described herein again.

The foregoing descriptions are merely implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Thus, the protection scope of the present disclosure shall be subject to the protection scope of the claims.

1. A method for processing a paging, comprising:
receiving, by a terminal device, a paging request for a non-current connection system forwarded by an access network device; and
in response to a current connection system being in a busy status, sending, by the terminal device, a Radio Resource Control (RRC) resume request message with a resume cause information element excluded to the access network device, or sending, by the terminal device, a busy indication RRC message to the access network device,
wherein the terminal device is equipped with a first communication card and a second communication card, wherein the terminal device is in communication with the current connection system through the first communication card, and the terminal device is in communication with the non-current connection system through the second communication card.

2. The method according to claim 1, wherein the RRC resume request message comprises a Message Authentication Code (MAC), wherein input parameters required to generate the MAC comprise a specified message content, an integrity key, a count value, a bearer identity, transmission direction information, and a busy token.

3. The method according to claim 2, further comprising:
performing, by the terminal device, according to the integrity key, the specified message content, the count value, the bearer identity, the transmission direction information, and the busy token, message authentication code calculation to generate the MAC.

4. The method according to claim 1, wherein the busy indication RRC message comprises an MAC, wherein input parameters required to generate the MAC comprise an integrity key, a count value, a bearer identity, transmission direction information, and a busy token.

5. The method according to claim 4, further comprising:
performing, by the terminal device, according to the integrity key, the count value, the bearer identity, the transmission direction information, and the busy token, message authentication code calculation to generate the MAC.

6. The method according to claim 1, wherein the method further comprises:
receiving, by the terminal device, a busy token forwarded by the access network device before receiving the paging request for the non-current connection system forwarded by the access network device.

7. A method for processing a paging, comprising:
forwarding, by an access network device, a paging request for a non-current connection system to a terminal device; and
in response to receiving, by the access network device, a Radio Resource Control (RRC) resume request message of the terminal device with a resume cause information element excluded or receiving, by the access network device, a busy indication RRC message of the terminal device, determining that a current connection system of the terminal device is in a busy status.

8. The method according to claim 7, wherein the determining that the current connection system of the terminal device is in the busy status comprises:
extracting, by the access network device, a first Message Authentication Code (MAC) from the RRC resume request message;
obtaining, by the access network device, input parameters required to generate a second MAC according to the RRC resume request message;
generating, by the access network device, the second MAC according to the input parameters required to generate the second MAC; and
in response to the first MAC and the second MAC being consistent, determining that the current connection system of the terminal device is in the busy status.

9. The method according to claim 8, wherein the input parameters required to generate the second MAC comprise a specified message content, an integrity key, a count value, a bearer identity, transmission direction information, and a busy token.

10. The method according to claim 7, wherein the determining that the current connection system of the terminal device is in the busy status comprises:
extracting, by the access network device, a first MAC from the busy indication RRC message;
obtaining, by the access network device, input parameters required to generate a second MAC according to the busy indication RRC message;
generating, by the access network device, the second MAC according to the input parameters required to generate the second MAC; and
in response to the first MAC and the second MAC being consistent, determining that the current connection system of the terminal device is in the busy status.

11. The method according to claim 10, wherein the input parameters required to generate the second MAC comprise an integrity key, a count value, a bearer identity, transmission direction information, and a busy token.

12. The method according to claim 7, wherein the method further comprises:
receiving, by the access network device, a busy token sent by a core network device; and
forwarding, by the access network device, the busy token to the terminal device before forwarding the paging request for the non-current connection system to the terminal device.

13. The method according to claim 12, wherein the receiving the busy token sent by the core network device comprises:
receiving, by the access network device, a terminal device context sent by the core network device, wherein the terminal device context comprises the busy token.

14-15. (canceled)

16. A terminal device, comprising a processor and a memory, wherein a computer program is stored in the memory, and the processor is configured to perform the computer program stored in the memory to cause the terminal device to execute acts comprising:
receiving a paging request for a non-current connection system forwarded by an access network device; and
in response to a current connection system being in a busy status, sending a Radio Resource Control (RRC) resume request message with a resume cause information element excluded to the access network device, or sending, by the terminal device, a busy indication RRC message to the access network device,
wherein the terminal device is equipped with a first communication card and a second communication card, wherein the terminal device is in communication with the current connection system through the first communication card, and the terminal device is in communication with the non-current connection system through the second communication card.

17. A network device, comprising a processor and a memory, wherein a computer program is stored in the memory, and the processor is configured to perform the computer program stored in the memory to cause the network device to execute the method according to claim 7.

18-21. (canceled)

22. The terminal device according to claim 16, wherein the RRC resume request message comprises a Message Authentication Code (MAC), wherein input parameters required to generate the MAC comprise a specified message content, an integrity key, a count value, a bearer identity, transmission direction information, and a busy token.

23. The terminal device according to claim 22, wherein the processor is further configured to:
perform, according to the integrity key, the specified message content, the count value, the bearer identity, the transmission direction information, and the busy token, message authentication code calculation to generate the MAC.

24. The terminal device according to claim 16, wherein the busy indication RRC message comprises an MAC, wherein input parameters required to generate the MAC comprise an integrity key, a count value, a bearer identity, transmission direction information, and a busy token.

25. The terminal device according to claim 24, wherein the processor is further configured to:
perform, according to the integrity key, the count value, the bearer identity, the transmission direction information, and the busy token, message authentication code calculation to generate the MAC.

26. The terminal device according to claim 16, wherein the processor is further configured to:
receive a busy token forwarded by the access network device before receiving the paging request for the non-current connection system forwarded by the access network device.
